(19) United States
(12) Patent Application Publication
(10) Pub. No.: US 2021/0316213 A1
(43) Pub. Date: Oct. 14, 2021

(54) APPARATUS AND METHOD FOR PROVIDING STREAMING VIDEO BY APPLICATION PROGRAM

(71) Applicant: VOLTHOLE INC., Seongnam-si Gyeonggi-do (KR)

(72) Inventors: Seung Joon YANG, Uiwang-si Gyeonggi-do (KR); Sun Joo MOON, Seoul (KR)

(73) Assignee: VOLTHOLE INC., Seongnam-si Gyeonggi-do (KR)

(21) Appl. No.: 17/358,188

(22) Filed: Jun. 25, 2021

Related U.S. Application Data
(63) Continuation of application No. PCT/KR2020/095090, filed on Jul. 27, 2020.

(30) Foreign Application Priority Data
Aug. 9, 2019 (KR) 10-2019-0097186

(51) Int. Cl. A63F 13/355; A63F 13/358; A63F 13/335; H04N 21/2343; H04N 21/2365; H04N 21/478

(52) U.S. Cl. CPC A63F 13/355; A63F 13/358; H04N 21/4781; H04N 21/234363; H04N 21/2365; A63F 13/335

(57) ABSTRACT

An apparatus and a method for providing a streaming video by an application program are provided. A method for providing a streaming video by an application program includes a step of selecting two or more cloud game streaming videos according to a preset condition from [symbol] amon₁₁lity of cloud game streaming videos output by executing a plurality of cloud game application programs from among a plurality of cloud games, a step of generating one integrated streaming video by combining the selected two or more cloud game streaming videos such that the two or more cloud game streaming videos are output on one screen, and a step of extracting cloud game videos in respectively different progress situations corresponding to the cloud game requested to be executed by two or more user terminals from among the integrated streaming videos and providing the cloud game video to a corresponding user terminal.

### CROSS REFERENCE TO RELATED APPLICATION

This application is a continuation of International Application No. PCT/KR2020/095090 filed on Jul. 27, 2020, which claims priority to Korean Patent Application No. 10-2019-0097186 filed on Aug. 9, 2019, the entire contents of which are herein incorporated by reference.

### TECHNICAL FIELD

The present disclosure relates to an apparatus and a method for providing streaming video by an application program. In more detail, the present disclosure relates to an apparatus and a method for providing a streaming video by an application program, in which the streaming video outputted by executing a plurality of application programs can be encoded and provided to a user.

### BACKGROUND

In recent years, with the development of computer-related information and communication technology, a game industry has been also rapidly developing. Conventional computer games were mainly arcade games or video games of a simple plot, but with the development of multimedia technology and network technology, games of a completely different dimension from the previous one are being developed one after another. In particular, the spread of high-speed Internet and wireless Internet was an opportunity to revolutionize the game industry by generating a new game field called multi-user online game.

In addition, a technology that provides cloud game services in a streaming method to a number of user terminals supporting computing and networking functions is attracting attention. A technology has been developed in which an input signal is received from the user terminal, a game is executed on a server in response to the input signal, and a screen of an execution result of a game is provided to a user terminal to allow the user to enjoy the game.

The cloud games can be serviced without restrictions between devices such as PC, mobile device, and console, and can be easily enjoyed by simply ‘subscribing’ to the service without ‘owning’ by downloading the content. Since the cloud game server processes an operation of the game, there is an advantage that the user can enjoy the latest games regardless of the performance of the connected PC or game console.

Unlike existing video streaming services, such a cloud game has a continuous interaction that operates and processes massive game data on the server and simultaneously reflects a game control signal of the user to the server. Therefore, the cloud and network environment are important.

In a case of a conventional cloud game service, as illustrated in FIG. 1, in a case where the cloud game is executed on a plurality of user terminals 40, a main computing device 10 executes the cloud game corresponding to each user terminal. In order to provide a streaming video of the executed cloud game, a separate auxiliary computing device 20 is provided to encode each streaming video.

However, in the case of such a conventional cloud game service, since the separate auxiliary computing device 20 has to be provided in addition to the main computing device 10 for executing the cloud game, there is a problem that a huge cost is required to build a server for providing the service.

In addition, since a manipulation input from the user terminal 40 for a cloud game manipulation is transmitted to the main computing device 10 via the auxiliary computing device 20, there is a problem that an input from the user is not quickly reflected in the game, that is, latency occurs.

In order to solve this problem, in the related art, there has been an attempt to provide the cloud game service directly from the main computing device 10 to the plurality of user terminals 40 without going through the auxiliary computing device 20 illustrated in FIG. 1. However, in a case where a plurality of cloud games are executed on the main computing device 10, an overlap phenomenon and noise occur between video, audio, and manipulation signals, and data has to be separated in order to eliminate this phenomenon. Therefore, in the prior art, in order to avoid such an interference phenomenon, the cloud game service has to be provided by driving a plurality of operating systems through a plurality of virtual machines. Accordingly, the main computing device 10 requires to use the plurality of virtual machines, resulting in an overload, and sometimes wastes a memory due to unnecessary driving of a virtual machine in which a cloud game is not executed. This directly became a factor that deteriorates the provision quality of the cloud game services.

Therefore, there is a need to develop a method for providing a streaming video to overcome limitations of the cloud game service and provide a high-quality cloud game service.

### SUMMARY OF INVENTION

### Technical Problem

A technical problem to be solved by the present disclosure is to provide an apparatus and a method for providing a streaming video by an application program by combining and encoding a plurality of streaming videos output by executing a plurality of cloud games, so that a separate auxiliary computing device for individually encoding each streaming video is not required.

Another technical problem to be solved by the present disclosure is to provide an apparatus and a method for providing a streaming video by an application program capable of encoding a plurality of streaming videos with only one encoding operation by generating one integrated streaming video by combining a plurality of streaming videos and encoding the integrated streaming video.

Another technical problem to be solved by the present disclosure is to provide an apparatus and a method for providing a streaming video by an application program capable of dramatically reducing a delay time for game manipulation by transmitting a game manipulation input received from a user terminal to a main computing device that provides a cloud game service without going through a separate auxiliary computing device.

Another technical problem to be solved by the present disclosure is to provide an apparatus and a method for providing a streaming video by an application program for solving the conventional problem of providing low-quality streaming contents through a capturing method as the main computing device directly receives and encodes streaming contents from an external server.

Another technical problem to be solved by the present disclosure is to provide an apparatus and a method for providing a streaming video by an application program capable of rendering a plurality of streaming contents that do not interfere with each other without using a plurality of virtual machines by a main computing device.

Another technical problem to be solved by the present disclosure is to provide an apparatus and a method for providing a streaming video by an application program in which the main computing device can directly receive non-decoded data from a server providing a game service for rendering streaming contents. The technical problems of the present distance are not limited to the technical problems mentioned above, and other technical problems that are not mentioned will be clearly understood by those skilled in the art from the following description.

### Solution to Problem

In order to solve the technical problems described above, a method for providing a streaming video by an application program according to one example of the present disclosure may include: a step of selecting two or more streaming videos from among a plurality of streaming videos output by executing a plurality of application programs according to a request of a user; a step of generating one integrated streaming video by combining the selected two or more streaming videos such that the selected two or more streaming videos are output on one screen; and a step of extracting a streaming video corresponding to an application program requested to be executed from a user terminal from among the encoded integrated streaming videos, and providing the streaming video to the user terminal.

In one example, the step of selecting the two or more streaming videos may include a step of determining the number of streaming videos selected based on a resolution of a screen on which the integrated streaming video is output.

In one example, the step of selecting the two or more cloud game streaming videos according to the resolution of the screen on which the integrated streaming video is output may include a step of selecting four streaming videos from among the plurality of streaming videos when the resolution of the screen is 4K resolution, and a step of selecting 16 streaming videos from among the plurality of streaming videos when the resolution of the screen is 8K resolution.

In one example, the step of selecting the two or more streaming videos may include a step of selecting two or more streaming videos from among a plurality of cloud game streaming videos output by executing a plurality of application programs having the same graphic specification for executing the application program.

In one example, the step of selecting the two or more cloud game streaming videos may include a step of selecting two or more streaming videos from among a plurality of streaming videos output by executing a plurality of application programs having the same category of the application program.

In one example, the step of selecting the two or more streaming videos may include a step of selecting two or more streaming videos from among a plurality of streaming videos output by repeatedly executing the same application program in response to an execution request received from user terminals different from each other.

In one example, a step of obtaining a user input for a first application program from the first user terminal may be further included, and the step of generating the integrated streaming video may include a step of updating a first streaming video of the first application program included in the integrated streaming video to a streaming video that is changed according to the user input.

In one example, the cloud game application program may be a game client program.

In one example, the step of selecting the two or more streaming videos may include a step of acquiring a streaming video of the application program in a video rendering buffer of the application program.

In one example, the step of acquiring the streaming video of the application program may include a step of real-time updating a screen generated by the application program in the video rendering buffer according to an API call of a streaming library embedded in the application program; a step of acquiring an address of the video rendering buffer according to the API call of the streaming library; and a step of acquiring a streaming video of the application program by using the address of the video rendering buffer.

In one example, the video rendering buffer may be formed on a graphic interface built-in memory of the computing device, and may be formed separately from a basic video rendering buffer of the application program.

In one example, the video rendering buffer may be formed on a RAM of the computing device, and may be formed separately from the basic video rendering buffer of the application program.

In one example, the step of extracting and providing only the streaming video correspond to the application program requested to be executed from the user terminal from among the encoded integrated streaming videos may include a step of acquiring sound data of the application program in a sound rendering buffer of the application program requested to be executed from the user terminal; a step of generating an output sound by encoding sound data of the application program; and a step of providing the output sound of the application program together with the extracted streaming video to the user terminal.

In order to solve the technical problems described above, there is provided a server for providing a streaming video by an application program according to another example of the present disclosure may include a processor; a network interface; a memory; and a computer program loaded in the memory and executed by the processor. The computer program may include: an instruction that selects two or more streaming videos according to a preset condition from among a plurality of streaming videos output by executing a plurality of applications program according to a request of a user; an instruction that generates one integrated streaming video by combining the selected two or more streaming videos such that the selected two or more streaming videos are output on one screen; an instruction that encodes the integrated streaming video; and an instruction that extracts a streaming video corresponding to an application program requested to be executed from the user terminal from among the encoded integrated streaming videos, and provides the streaming video to the user terminal.

### Advantageous Effects

In the apparatus and the method for providing the streaming video by the application program according to an example of the present disclosure, the plurality of streaming videos, which are output by executing the plurality of cloud games are combined and encoded, so that a separate auxiliary computing device for individually encoding each streaming video is not required.

In the apparatus and the method for providing the streaming video by the application program according to another example of the present disclosure, the plurality of streaming videos are combined to generate one integrated streaming video, and the integrated streaming video is encoded, and thereby a plurality of streaming videos can be encoded only by one encoding operation.

In the apparatus and the method for providing the streaming video by the application program according to another example of the present disclosure, the game manipulation input which is received from the user terminal is transmitted to the main computing device that provides the cloud game service without passing through a separate auxiliary computing device. Therefore, a delay time for the game manipulation can be drastically reduced.

In the apparatus and the method for providing the streaming video by the application program according to another example of the present disclosure, an apparatus and a method for providing a streaming video by an application program are provided for solving the conventional problem of providing low-quality streaming contents through a capturing method as the main computing device directly receives and encodes streaming contents from an external server.

Another technical problem to be solved by the present disclosure is to provide an apparatus and a method for providing a streaming video by an application program capable of rendering a plurality of streaming contents that do not interfere with each other without using a plurality of virtual machines by the main computing device.

In the apparatus and the method for providing the streaming video by the application program according to another example of the present disclosure, the main computing device can directly receive non-decoded data from a server providing a game service for rendering streaming contents.

### BRIEF DESCRIPTION OF THE DRAWINGS

FIG. 1 is a configuration diagram of a conventional cloud game service providing system.

FIG. 2 is a configuration diagram of a system for providing a streaming video by an application program according to an example of the present disclosure.

FIG. 3 is a flowchart for explaining a method for providing a streaming video by an application program according to another example of the present disclosure.

FIG. 4 is a flowchart for explaining a method for selecting a streaming video by using a resolution of a screen in some examples.

FIG. 5 is a flowchart for explaining a method for selecting a streaming video according to a graphic specification of an application program in some examples.

FIG. 6 is a flowchart for explaining a method for selecting a streaming video according to a category of an application program in some examples.

FIG. 7 is an exemplary view illustrating a form of an integrated streaming video in a case where the resolution of the screen is 4K resolution in some examples.

FIG. 8 is an exemplary view illustrating a form of an integrated streaming video in a case where the screen resolution is 8K resolution in some examples.

FIG. 9 is an exemplary view illustrating a form of providing an integrated streaming video to a user terminal in some examples.

FIG. 10 is a configuration diagram of a system for providing a streaming video by an application program according to another example of the present disclosure.

FIG. 11 is an exemplary diagram illustrating a method for executing a plurality of application programs by a streaming video providing server of a conventional application program.

FIG. 12 is an exemplary diagram illustrating a method for executing a plurality of application programs by a streaming video providing server according to another example of the present disclosure.

FIG. 13 is a configuration diagram of a streaming video providing system of an application program according to another example of the present disclosure.

FIG. 14 is a flowchart for explaining a method for providing a streaming video by an application program according to another example of the present disclosure.

FIG. 15 is a flowchart for explaining a part of steps of FIG. 14 in detail.

FIG. 16 is a hardware configuration diagram of a streaming video providing server of an application program according to another example of the present disclosure.

### DETAILED DESCRIPTION

A method for providing a streaming video by an application program according to an example of the present disclosure may include: a step of separately proceeding a cloud game according to a request of each of two or more user terminals by using a manipulation signal for two or more cloud games selected according to the request of the two or more user terminals, from among a plurality of cloud games; a step of selecting two or more cloud game streaming videos according to a preset condition from among a plurality of cloud game streaming videos output by executing a plurality of cloud game application programs in progress; a step of generating one integrated streaming video by combining the selected two or more cloud game streaming videos such that the selected two or more cloud game streaming videos are output on one screen; a step of encoding the integrated streaming video; and a step of extracting a cloud game streaming video corresponding to a cloud game application program requested to be executed from the two or more user terminals from among the encoded integrated streaming videos, and providing the cloud game streaming video to the two or more user terminals. The step of providing the cloud game streaming video to the two or more user terminals may include a step of extracting cloud game videos in respectively different progress situations corresponding to the cloud game requested to be executed by the two or more user terminals from among the integrated streaming videos, and providing the cloud game video to a corresponding user terminal.

### Mode of Disclosure

Hereinafter, examples of the present disclosure will be described in detail with reference to the accompanying drawings. Advantages and features of the present disclosure, and methods of achieving them will be apparent with reference to the examples described below in detail together with the accompanying drawings. However, the present disclosure is not limited to the examples disclosed below, and may be implemented in various different forms. The examples are provided to completely inform the scope of the disclosure to those skilled in the art to which the present disclosure belongs, and the disclosure is only defined by the scope of the claims. The same reference numerals refer to the same configuration elements throughout the specification.

Unless otherwise defined, all terms (including technical and scientific terms) used in the present specification may be used with meanings that can be commonly understood by those skilled in the art to which the present disclosure belongs. In addition, terms defined in a commonly used dictionary are not interpreted ideally or excessively unless explicitly defined specifically. The terms used in the present specification are for describing the examples and are not intended to limit the present disclosure. In this specification, the singular form also includes a plural form unless specifically stated in the phrase.

In addition, in the present specification, the application program is a cloud game, and the streaming video output by executing the application program is described as a game streaming video output by executing the cloud game. However, it should be noted that this is only an example to aid understanding of the present disclosure, and is not limited thereto.

Hereinafter, some examples of the present disclosure will be described with reference to the drawings.

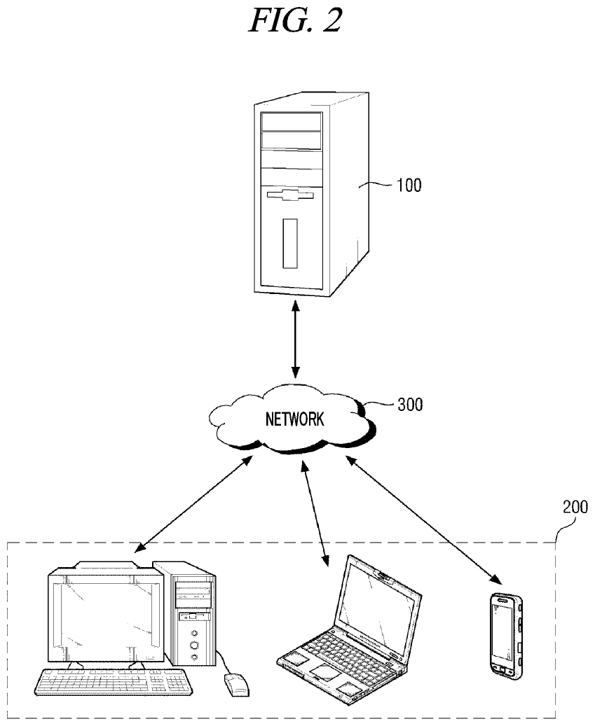

FIG. 2 is a configuration diagram of a streaming video providing system of the application program according to an example of the present disclosure.

Referring to FIG. 2, the streaming video providing system of the application program according to an example of the present disclosure may include a streaming video providing server 100 of the application program, a user terminal 200, and a network 300.

Here, the streaming video providing system of the application program illustrated in FIG. 2 is according to an example, and configuration elements thereof are not limited to those of the example illustrated in FIG. 2, and it should be noted that the configuration elements may be added, changed, or deleted as necessary.

First, the streaming video providing server 100 of the application program may execute a plurality of cloud games according to an application program execution request received from the user terminal 200.

In addition, the streaming video providing server 100 of the application program may select two or more streaming videos according to a preset condition from among a plurality of cloud game streaming videos output by executing a plurality of cloud games, and combine the selected two or more streaming videos to generate and encode one integrated streaming video.

In addition, the streaming video providing server 100 of the application program may provide the encoded integrated streaming video to the user terminal 200, and extract and provide only the game streaming video corresponding to the cloud game requested to be executed from the user terminal 200 from among the encoded integrated streaming videos. Here, the streaming video providing server 100 of the application program may communicate with a plurality of user terminals 200 through the network 300.

The user terminal 200 may receive and output the game streaming video provided from the streaming video providing server 100 of the application program. To this end, the user terminal 200 may include a display for outputting a video. However, the present disclosure is not limited thereto, and the user terminal 200 may perform wired/wireless communication with an external display device to transmit the game streaming video provided from the streaming video providing server 100 of the application program to the external display device, and thereby the game streaming video can be output.

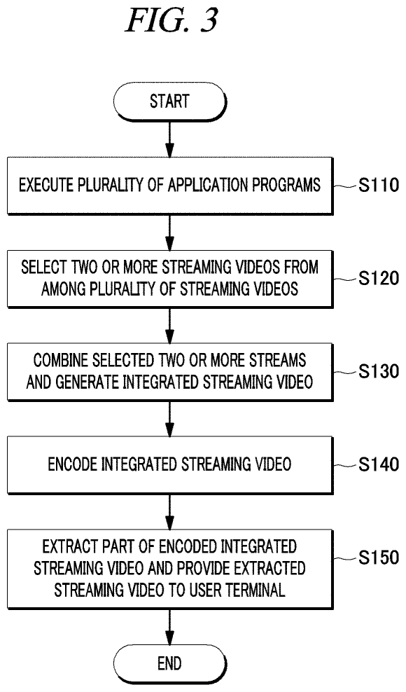

In addition, the user terminal 200 may receive a user input for manipulating the cloud game. To this end, the user terminal 200 may further include a manipulation controller. For example, the manipulation controller may be a manipulation controller GUI that is output to a display included in the user terminal 200. However, the present disclosure is not limited thereto, and the manipulation controller may be an external controller terminal capable of performing wired or wireless communication with the user terminal 200. Hereinafter, a method for providing the streaming video to the user by the streaming video providing server 100 of the application program will be described with reference to FIGS. 3 to 9.

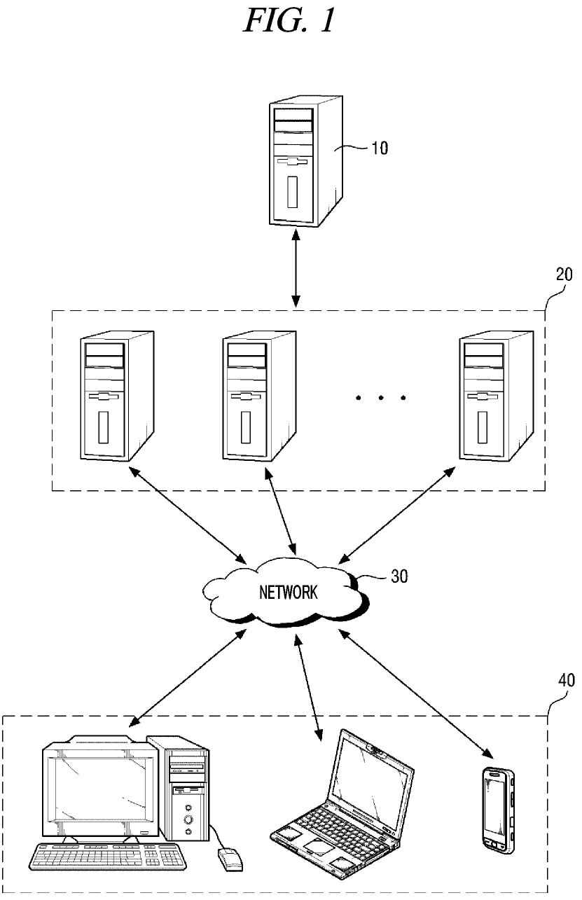

The method for providing the streaming video by the application program may be performed in various systems and/or environments, but to provide convenience of understanding, it is assumed that the environment is the same as those illustrated in FIGS. 1 and 2.

In addition, unless otherwise noted, it is assumed that each step of the method for providing the streaming video by the application program is performed by the streaming video providing server 100 of the application program. Accordingly, in a case where the subject of each operation is omitted, it may be understood that each operation is performed by the streaming video providing server 100 of the application program. In addition, it goes without saying that in the methods described below, the order of respective operations may be changed within a range in which an execution order may be logically changed as necessary.

FIG. 3 is a flowchart for explaining the method for providing the streaming video by the application program according to another example of the present disclosure.

Referring to FIG. 3, first, a plurality of application programs are executed (S110). For example, in a case where the streaming video providing server 100 of the application program receives an execution request for a first application program from a first user terminal, and receives an execution request for a second application program from a 2nd user terminal, the first application program and the second application program may be executed in response to the execution requests. In addition, in a case where the streaming video providing server 100 of the application program receives the execution request for the first application program, which is the same application program, from the first user terminal and the second user terminal, respectively, the first application program, which is the same application program, may be executed twice according to the execution requests of the first user terminal and the second user terminal.

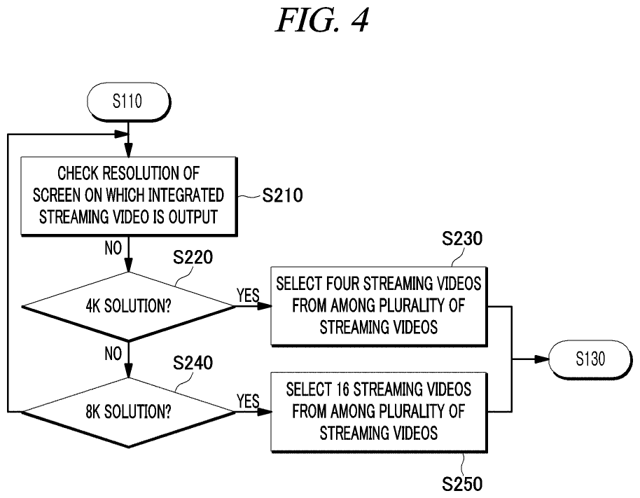

Next, two or more streaming videos are selected from among a plurality of streaming videos output as the plurality of application programs are executed in step S110 (S120). Hereinafter, various methods for selecting two or more streaming videos from among the plurality of streaming videos will be described with reference to FIGS. 4 to 6.

In an example, the streaming video providing server 100 of the application program may select two or more streaming videos according to a resolution of a screen on which an integrated streaming video is output.

Referring to FIG. 4, after step S110 of FIG. 3, the resolution of the screen on which the integrated streaming video is output is checked (S210).

Next, it is determined whether the resolution of the screen is 4K resolution (S220), and in a case where it is determined that the resolution is the 4K resolution in step S220, four streaming videos are selected from among the plurality of streaming videos output by executing the plurality of application programs (S230).

Next, in a case where it is determined in step S220 that the resolution of the screen is not the 4K resolution, it is determined whether the resolution of the screen is 8K resolution (S240), and in response to the determination that the resolution is the 8K resolution, 16 streaming videos are selected from among the plurality of streaming videos output by executing the plurality of application programs (S250).

If, in steps S220 and S240, in a case where it is determined that the resolution of the screen does not match at least one of the 4K resolution and the 8K resolution, step S210 may be performed again. However, the present disclosure is not limited thereto, and in a case where it is determined that the resolution of the screen does not match at least one of the 4K resolution and the 8K resolution, a guide message requesting to check and reset the resolution may be output to the outside.

In another example, the streaming video providing server 100 of the application program may select two or more streaming videos from among a plurality of streaming videos output by executing a plurality of application programs having the same graphic specification for executing the application program.

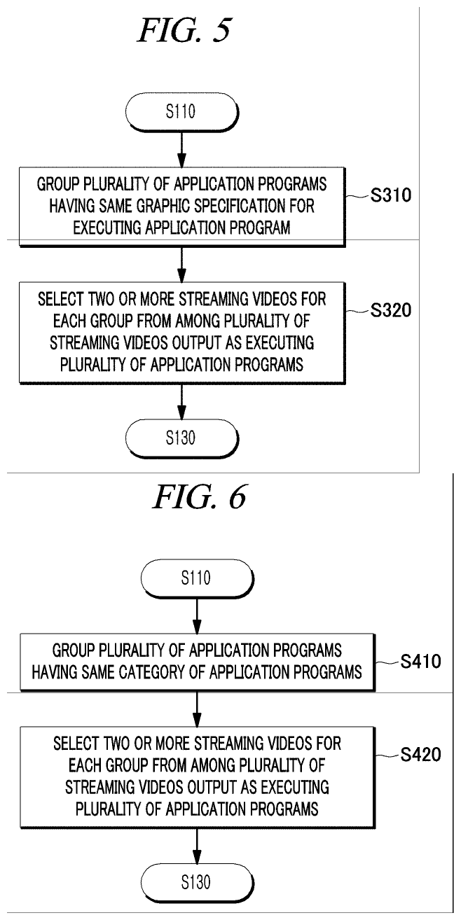

Referring to FIG. 5, after step S110 of FIG. 3, the plurality of application programs having the same graphic specification for executing the application program are grouped (S310). For example, the streaming video providing server 100 of the application program may be subdivided into five stages according to the graphic specifications, to group into a first application program group that requires a highest-level graphic specification for the plurality of application programs, a second application program group that requires a high-level graphic specification, a third application program group that requires a medium-level graphic specification, a fourth application program group that requires a low-level graphic specification, and a fifth application program group that requires a lowest-level graphic specification. However, the present disclosure is not limited thereto.

Next, two or more streaming videos are selected for each group from among the plurality of streaming videos output as the plurality of application programs are executed (S320). For example, in a case where four streaming videos are selected according to a preset condition, the streaming video providing server 100 of the application program may select four streaming videos for each group of the first application program group, the second application program group, the third application program group, the fourth application program group, and the fifth application program group.

In another example, the streaming video providing server 100 of the application program may select two or more streaming videos from among the plurality of streaming videos output by executing the plurality of application programs having the same category of the application programs.

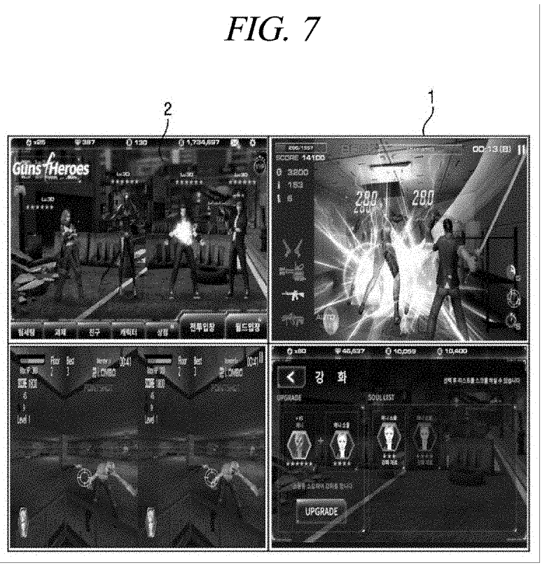

Referring to FIG. 6, after step S110 of FIG. 3, the plurality of application programs having the same category of the application programs are grouped (S410). For example, in a case where the application program is the cloud game, the category of the application program may mean a genre of the cloud game, and the streaming video providing server 100 of the application program may group cloud games having the same or similar genre with each other. However, the present disclosure is not limited thereto.

Next, two or more streaming videos are selected for each group from among the plurality of streaming videos output by executing the plurality of application programs (S420). For example, in a case where four streaming videos are selected according to a preset condition, the streaming video providing server 100 of the application program selects four streaming videos from among the plurality of streaming videos for cloud games of a sports genre, and four streaming videos may be selected from among the plurality of streaming videos for cloud games of a FPS genre.

In another example, the streaming video providing server 100 of the application program may select two or more streaming videos from among the plurality of streaming videos output by repeatedly executing the same application program in response to an execution request received from different user terminals. In a case where the plurality of streaming videos include four first streaming videos for the first application program and four second streaming videos for the second application program, the streaming video providing server 100 of the application program may select only four first streaming videos or four second streaming videos from among the plurality of streaming videos. However, the present disclosure is not limited thereto.

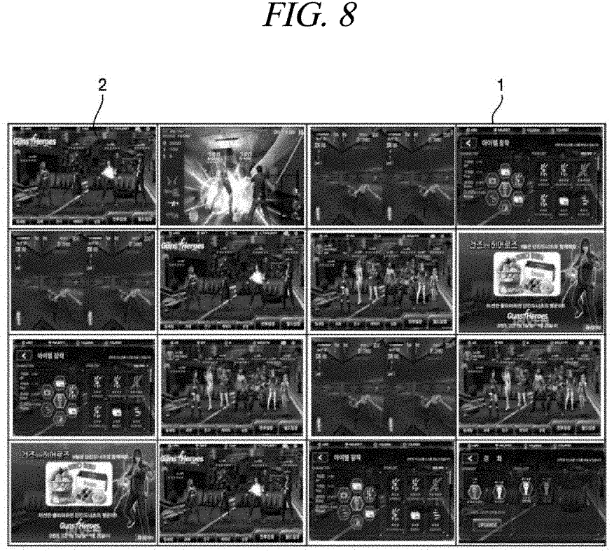

Referring back to FIG. 3, after step S120, two or more streams selected in step S120 are combined and one integrated streaming video is generated to be output on one screen (S130). For example, in a case where the resolution of the screen is the 4K resolution, the streaming video providing server 100 of the application program combines four streaming videos in a 2*2 format as illustrated in FIG. 7 to generate one integrated streaming video. In addition, in a case where the resolution of the screen is the 8K resolution, the streaming video providing server 100 of the application program may combine 16 streaming videos in a 4*4 format as illustrated in FIG. 8 to generate one integrated streaming video. However, the present disclosure is not limited thereto. In this case, in another example, when displaying a plurality of videos, the streaming video providing server 100 of the application program may form dividing lines capable of dividing each video as illustrated in FIGS. 7 and 8. Next, the integrated streaming video generated in step S130 is encoded (S140).

Here, with regard to the streaming video encoding method performed by the streaming video providing server 100 of the application program, various documents such as “H.264-based Region-of-interest (ROI) Cognitive Video Encoding”, Albert Y. Chung, Sukkyu Lee, and Hwangnam Kim, Korea Information Science Society, ITU-T H. 265 standard may be referenced.

Next, a part of the integrated streaming video encoded in step S140 is extracted and the extracted streaming video is provided to the user terminal (S150). For example, the streaming video providing server 100 of the application program provides the encoded integrated streaming video to the user terminal 200, and only the streaming video corresponding to the application program requested to be executed from the user terminal 200 from among the encoded integrated streaming videos may be provided to the user terminal 200.

In addition, in another example, the streaming video providing server 100 of the application program identifies the dividing lines for classifying a plurality of videos when extracting a part of the encoded video, and determines that the videos are divided based on the dividing lines, and thereby each video can be classified and extracted.

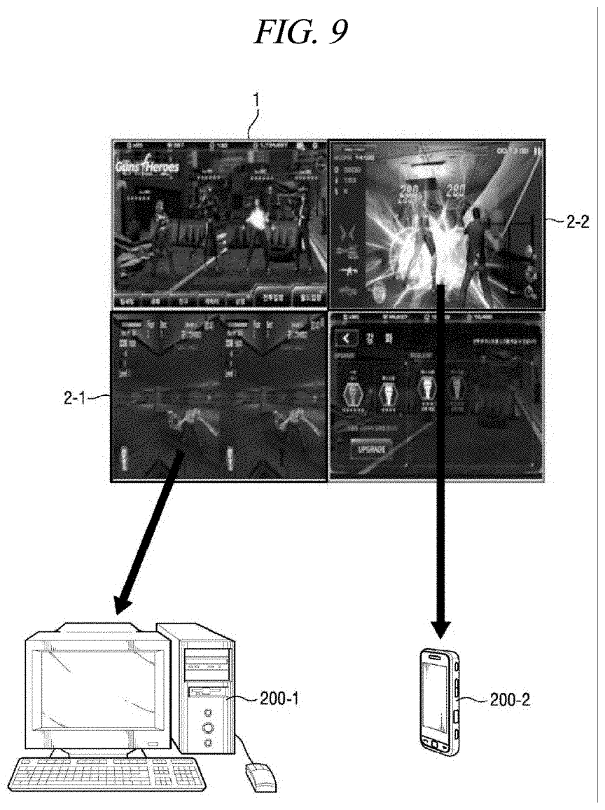

Hereinafter, the description thereof will be made with reference to FIG. 9.

Referring to FIG. 9, in a case where the resolution of the screen is the 4K resolution, the streaming video providing server 100 of the application program may generate and encode the integrated streaming video 1 of the 2*2 format as illustrated in FIG. 9. Thereafter, the streaming video providing server 100 of the application program provides the integrated streaming video 1 to a first user terminal 200-1 and a second user terminal 200-2, and only a streaming video 2-1 of the first application program requested to be executed by the first user terminal 200-1 from among the integrated streaming videos 1 may be extracted and provided to the first user terminal 200-1. In addition, the streaming video providing server 100 of the application program may extract only a streaming video 2-2 of the second application program requested to be executed by the second user terminal 200-2 from among the integrated streaming videos 1, and provided to the second user terminal 200-2. However, the present disclosure is not limited thereto.

In one example, the streaming video providing server 100 of the application program may obtain a user input for the first application program from the first user terminal 200-1 through the network 300 and update the first streaming video of the first application program included in the integrated streaming video to a streaming video that is changed according to the user input. However, the present disclosure is not limited thereto.

In other words, the streaming video providing server 100 of the application program according to an example of the present disclosure performs the encoding on the integrated streaming video generated by combining the plurality of streaming videos. Therefore, there is an advantage in that it is not necessary to have a plurality of auxiliary computing devices for encoding each of the plurality of streaming videos for providing the streaming video to the user terminal 200.

In addition, the streaming video providing server 100 of the application program according to an example of the present disclosure does not perform the encoding of the streaming video and the providing operation of the streaming video through the plurality of auxiliary computing devices, and performs, by itself, the encoding of the streaming video and the providing operation of the streaming video. Therefore, there is an advantage in that the latency can be drastically reduced.

In addition, the streaming video providing server 100 of the application program according to an example of the present disclosure directly receives the user input for manipulating the application program input from the user terminal 200 without passing through a separate auxiliary computing device. Therefore, there is an advantage in that the latency for the operation of the application program can be drastically reduced.

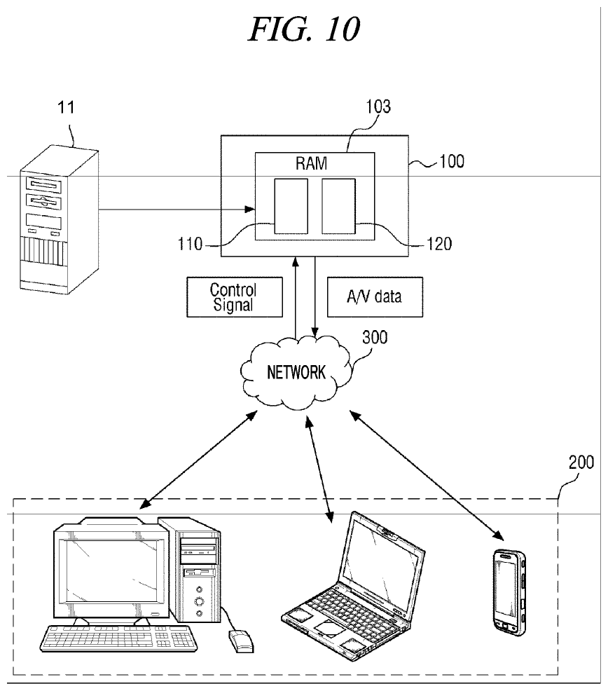

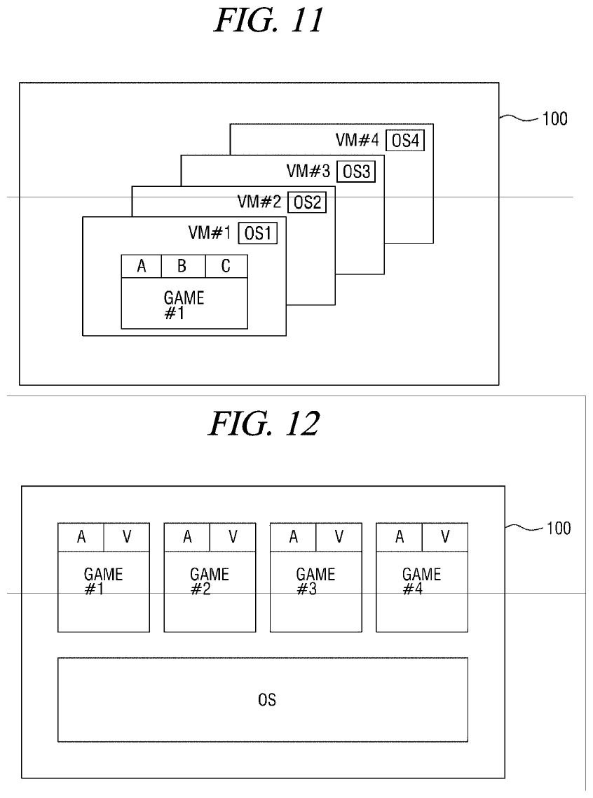

FIG. 10 is a configuration diagram of a streaming video providing system of an application program according to another example of the present disclosure, and FIG. 11 is a configuration diagram of a streaming video providing system of an application program according to another example of the present disclosure.

Referring to FIG. 10, the streaming video providing system of the application program according to another example of the present disclosure may include a content server 11, a streaming video providing server 100 of an application program, a user terminal 200, and a network 300.

Here, the streaming video providing system of the application program illustrated in FIG. 10 is according to an example, and the configuration elements thereof are not limited to those of the example illustrated in FIG. 10, and may be added, changed, or deleted as necessary. Meanwhile, since the user terminal 200 and the network 300 is the same as those described above, detailed description thereof will be omitted.

The content server 11 may be a server that provides the application program as an external server, but is not limited thereto, and may be a service provider that provides various contents such as game, video, or audio.

The streaming video providing server 100 of the application program may include a video rendering buffer 110 or a sound rendering buffer 120 in a memory (RAM) 103.

In another example, the video rendering buffer 110 is formed on the RAM of the computing device and may be formed separately from a basic video rendering buffer of the application program.

In an example, the video rendering buffer 110 is formed on a graphic interface built-in memory of the computing device, and may be formed separately from the basic video rendering buffer of the application program.

When acquiring the streaming video of the application program, the streaming video providing server 100 of the application program may obtain the streaming video according to an API call of a streaming library embedded in the application program.

After acquiring the address of the video rendering buffer 110 according to the API call of the streaming library, the streaming video providing server 100 of the application program may use the address of the video rendering buffer 110 to acquire the streaming video of the application program. In this case, the video rendering buffer 110 may update the video generated by the application program in real time.

In addition, the streaming video providing server 100 of the application program may directly acquire a control signal for the manipulation of the application program from the user terminal 200 to the memory to control the application program, and transmit an operation result thereof to the content server 11. Accordingly, the streaming video providing server 100 of the application program may receive an updated video according to the operation result on the control signal from the content server 11 in real time.

In the conventional cloud game server, there is a hassle of transmitting an video in a capture method after decoding the encoded data to be provided to the user terminal 200, but the streaming video by the streaming video providing system of the application program according to another example of the present disclosure can get rid of the hassle of capturing the encoded data because the streaming video providing server 100 of the application program can directly receive raw data from the video rendering buffer 110 and the sound rendering buffer 120, and process the data without capturing the encoded data.

FIG. 11 is an exemplary diagram illustrating a method in which a conventional streaming video providing server of an application program executes a plurality of application programs, and FIG. 12 is an exemplary diagram illustrating a method in which a streaming video providing server of an application program according to another example of the present disclosure executes a plurality of application programs.

Referring to FIG. 11, the conventional streaming video providing server for the application program drives a plurality of virtual machines (VM #1 to VM #4) to execute the plurality of application programs, and operating systems (OS1 to OS4) are executed in each of the driven virtual machines (VM #1 to VM #4).

The conventional streaming video providing server 100 of the application program receives the encoded streaming content to process a plurality of videos and a plurality of audio data at once. Therefore, the conventional streaming video providing server of the application program drives each of the virtual machines (VM #1 to VM #4) to provide the streaming content to the user terminal 200, and each of the virtual machines (VM #1 to VM #4) VM #4) has to provide the cloud game service by a method for capturing the already decoded streaming content.

Referring to FIG. 12, in the streaming video providing system of the application program according to another example of the present disclosure, the streaming video providing server 100 of the application program directly receives the raw data. Therefore, there is an advantage of being able to process multiple streaming contents without driving multiple operating systems. The streaming video providing system of the application program according to another example of the present disclosure drives one operating system as the streaming video providing server 100 of the application program directly processes the content provided from the video rendering buffer 110, and thereby multiple videos can be combined and encoded at once.

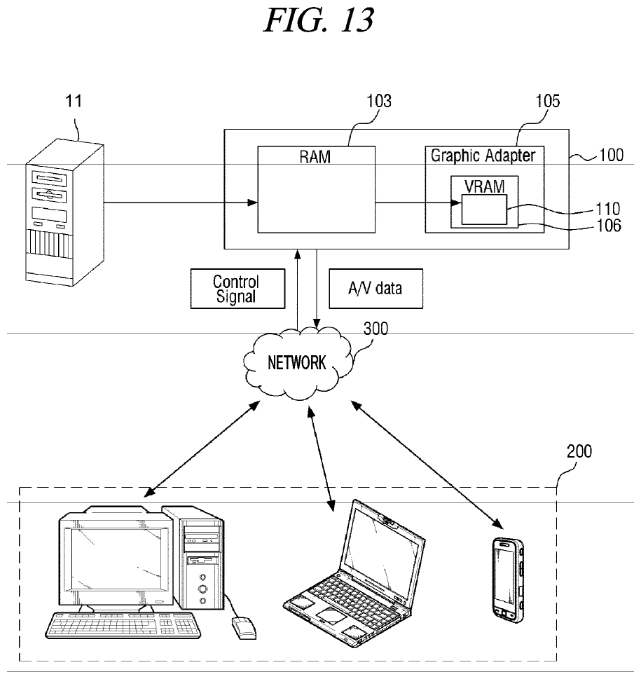

Referring to FIG. 13, the streaming video providing system of the application program according to another example of the present disclosure may include a content server 11, a streaming video providing server 100 of the application program, a user terminal 200, and a network 300.

Here, the streaming video providing system of the application program illustrated in FIG. 13 is according to an example, and configuration elements thereof are not limited to those of the example illustrated in FIG. 13, and may be added, changed, or deleted as necessary. Meanwhile, the content server 11, the user terminal 200, and the network 300 are the same as those described above, and thus detailed description thereof will be omitted.

In this example, the video rendering buffer 110 is formed on a VRAM 106, which is an internal memory of the graphic interface 105 of the streaming video providing server 100 of the application program, and may be formed separately from the basic video rendering buffer of the application program. In this case, the video rendering buffer 110 may acquire a video through the memory 103, but in another example, may directly acquire the video from the content server 11.

Accordingly, in the streaming video providing system of the application program according to another example of the present disclosure, the streaming video providing server 100 of the application program encodes a high-quality video using the VRAM 106. Therefore, there is an advantage that a high-quality video can be provided to the user terminal 200.

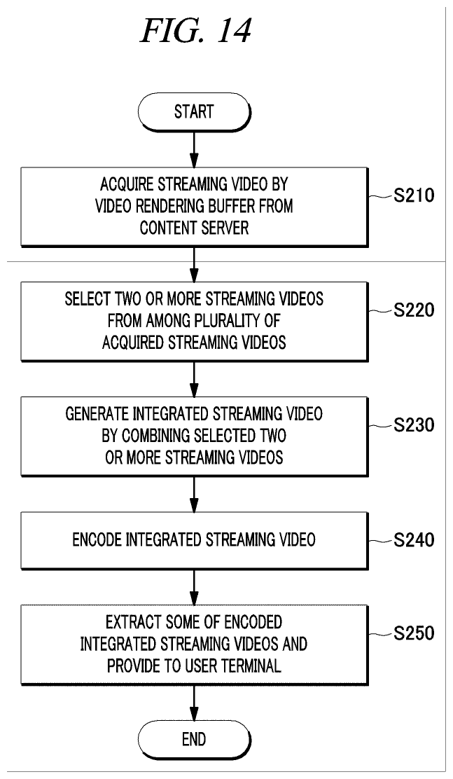

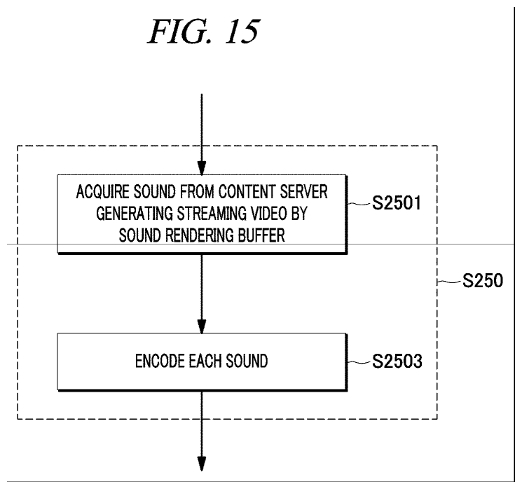

FIG. 14 is a flowchart for explaining a method for providing a streaming video by an application program according to another example of the present disclosure, and FIG. 15 is a flowchart for explaining a part of steps of FIG. 14 in detail.

The method for providing the streaming video by the application program according to another example of the present disclosure may be performed by the streaming video providing server 100 of the application program, and the streaming video may be acquired from the video rendering buffer 110 in step S210. Two or more streaming videos may be selected from among a plurality of streaming videos acquired in step S220. In step S230, an integrated streaming video is generated by combining the selected two or more streaming videos, and in step S240, the entire integrated streaming video may be encoded. In step S250, some of the encoded integrated streaming video may be extracted and provided to the user terminal.

Referring to FIG. 15, in the method for providing the streaming video by the application program according to another example of the present disclosure, in step S250 of extracting only the streaming video corresponding to the application program and providing the streaming video to the user terminal, rendered audio corresponding to the streaming video may be extracted and provided together with the streaming video.

Specifically, in step S250 of extracting only the streaming video corresponding to the application program and providing the streaming video to the user terminal, step S2501 of acquiring sound data of the application program from the sound rendering buffer 120 of the application program requested to be executed from the user terminal may be performed, and step S2503 of generating output sound by encoding the sound data of the application program may be performed. Thereafter, in step S250, the output sound of the application program may be provided to the user terminal together with the extracted streaming video.

The methods according to the examples of the present disclosure described so far may be performed by executing a computer program implemented in computer-readable code. The computer program may be transmitted from a first computing device to a second computing device through a network such as the Internet and installed in the second computing device, thereby being used in the second computing device. The first computing device and the second computing device include all of a server device, a physical server belonging to a server pool for cloud services, and a fixed computing device such as a desktop PC.

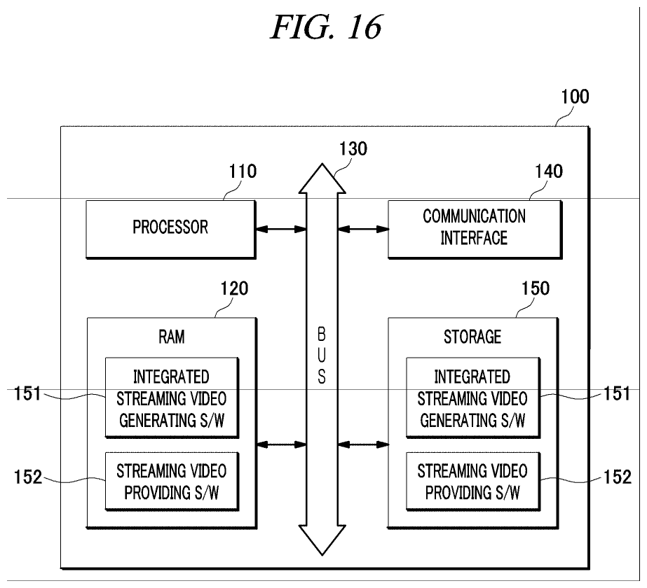

The computer program may be stored in a recording medium such as a DVD-ROM or a flash memory device. Hereinafter, a hardware configuration of the streaming video providing server 100 of the application program according to another example of the present disclosure will be described with reference to FIG. 16

FIG. 16 is a hardware configuration diagram of the streaming video providing server of the application program according to another example of the present disclosure.

Referring to FIG. 16, the streaming video providing server 100 of the application program according to another example of the present disclosure may include one or more processors 110, a memory 120 for loading a first computer program 151 and a second computer program 152 executed by the processor 110 a bus 130, a network interface 140, and a storage 150 for storing the first computer program 151 and the second computer program 152. Here, only the configuration elements related to the example of the present disclosure are illustrated in FIG. 16. Accordingly, those of ordinary skill in the art to which the present disclosure pertains can recognize that other general-purpose configuration elements may be further included in addition to the configuration elements illustrated in FIG. 16.

The processor 110 controls the overall operation of each configuration of the streaming video providing server 100 of the application program. The processor 110 may include a central processing unit (CPU), a microprocessor unit (MPU), a micro controller unit (MCU), a graphic processing unit (GPU), or any type of a processor well known in the technical field of the present disclosure. Further, the processor 110 may perform an operation on at least one application or program for executing the methods according to the examples of the present disclosure. Here, the streaming video providing server 100 of the application program illustrated in FIG. 16 is illustrated as including one processor 110, but is not limited thereto and may include a plurality of processors.

The memory 120 stores various types of data, commands and/or information. The memory 120 may load the first computer program 151 and the second computer program 152 from the storage 150 in order to execute the method/operation according to various examples of the present disclosure. When the first computer program 151 and the second computer program 152 are loaded in the memory 120, the processor 110 may execute one or more instructions constituting the first computer program 151 and the second computer program 152, thereby performing the method/operation of providing the streaming video of the application program. The memory 120 may be implemented as a volatile memory such as RAM, but the technical scope of the present disclosure is not limited thereto.

The bus 130 provides a communication function between the configuration elements of the streaming video providing server 100 of the application program. The bus 130 may be implemented as various types of buses such as an address bus, a data bus, and a control bus.

The network interface 140 supports wired/wireless Internet communication of the streaming video providing server 100 of the application program. In addition, the network interface 140 may support various communication methods other than Internet communication. To this end, the network interface 140 may be configured to include a communication module well known in the art. In some examples, the network interface 140 may be omitted.

The storage 150 may non-temporarily store the first computer program 151 and the second computer program 152. In a case where the application program is executed and manipulated through the streaming video providing server 100 of the application program, the storage 150 may store various types of data on the application program executed according to the execution and manipulation. For example, the storage 150 may store information on the application program to be executed, manipulation information on the application program, information on a user who requests the execution of the application program, or the like.

The storage 150 may be configured to include a nonvolatile memory such as a read only memory (ROM), an erasable programmable ROM (EPROM), an electrically erasable programmable ROM (EEPROM), or a flash memory, a hard disk, a removable disk, or any known computer-readable recording medium which is well in the technical field to which the present disclosure belongs.

The first computer program 151 and the second computer program 152 may include one or more instructions that allow, when being loaded in the memory 120, the processor 110 to perform the method/operation according to various examples of the present disclosure. That is, the processor 110 may perform the method/operation according to various examples of the present disclosure by executing the one or more instructions.

In one example, the first computer program 151 and the second computer program 152 may include an instruction that selects two or more streaming videos according to a preset condition from among a plurality of streaming videos output by executing a plurality of application programs according to the request of the user, an instruction that generates one integrated streaming video by combining the selected two or more streaming videos such that the selected two or more streaming videos are output on one screen, an instruction that encodes the integrated streaming video, and an instruction that provides the encoded integrated streaming video to the user terminal, extracts only a streaming video corresponding to the application program requested to be executed from the user terminal from among the encoded integrated streaming videos, and provides the streaming video to the user terminal.

So far, various examples of the present disclosure and effects according to the examples are described with reference to FIGS. 1 to 16. The effects according to the technical idea of the present disclosure are not limited to the above-mentioned effects, and other effects not mentioned will be clearly understood by those skilled in the art from the following description.

The examples of the present disclosure are described above with reference to the accompanying drawings, but can be implemented in other specific forms without changing the technical spirit or essential features by those skilled in the art to which the present disclosure pertains. Therefore, it should be understood that the examples described above are illustrative in all respects and not limiting.

What is claimed is:

1. A method for providing a streaming video by an application program in a method performed by a computing device, comprising:
a step of separately proceeding a cloud game according to a request of each of two or more user terminals by using a manipulation signal for two or more cloud games selected according to the request of the two or more user terminals, from among a plurality of cloud games;
a step of selecting two or more cloud game streaming videos according to a preset condition from among a plurality of cloud game streaming videos output by executing a plurality of cloud game application programs in progress;
a step of generating one integrated streaming video by combining the selected two or more cloud game streaming videos such that the selected two or more cloud game streaming videos are output on one screen;
a step of encoding the integrated streaming video; and
a step of extracting a cloud game streaming video corresponding to a cloud game application program requested to be executed from the two or more user terminals from among the encoded integrated streaming videos, and providing the cloud game streaming video to the two or more user terminals,
wherein the step of providing the cloud game streaming video to the two or more user terminals includes,
a step of extracting cloud game videos in respectively different progress situations corresponding to the cloud game requested to be executed by the two or more user terminals from among the integrated streaming videos, and providing the cloud game streaming video to a corresponding user terminal.

2. The method for providing a streaming video by an application program of claim 1,
wherein the step of selecting the two or more cloud game streaming videos includes,
a step of determining a number of cloud game streaming videos selected based on a resolution of a screen on which the integrated streaming video is output.

3. The method for providing a streaming video by an application program of claim 2,
wherein the step of determining the number of cloud game streaming videos selected based on the resolution of the screen on which the integrated streaming video is output includes,
a step of selecting 4 streaming videos from among the plurality of cloud game streaming videos when the resolution of the screen is 4 k resolution; and
a step of selecting 16 streaming videos from among the plurality of cloud game streaming videos when the resolution of the screen is 8 k resolution.

4. The method for providing a streaming video by an application program of claim 1,
wherein the step of selecting the two or more cloud game streaming videos includes,
a step of selecting two or more cloud game streaming videos from among a plurality of cloud game streaming videos output by executing a plurality of application programs having the same graphic specification for executing the application program.

5. The method for providing a streaming video by an application program of claim 1,
wherein the step of selecting the two or more cloud game streaming videos includes,
a step of selecting two or more cloud game streaming videos from among a plurality of cloud game streaming videos output by executing a plurality of application programs having the same category of the application program.

6. The method for providing a streaming video by an application program of claim 1,
wherein the step of selecting the two or more streaming videos includes,
a step of selecting two or more streaming videos from among a plurality of cloud game streaming videos output by repeatedly executing the same application program in response to an execution request received from user terminals different from each other.

7. The method for providing a streaming video by an application program of claim 1, further comprising:
a step of obtaining a user input for a first cloud game application program from a first user terminal,
wherein the step of generating the integrated streaming video includes,
a step of updating a first cloud game streaming video of the first cloud game application program included in the integrated streaming video to a cloud game streaming video that is changed according to the user input.

8. The method for providing a streaming video by an application program of claim 1,
wherein the cloud game application program is a cloud game client program.

9. A method for providing a streaming video by an application program in a method performed by a computing device, comprising:
a step of real-time updating a screen generated by a cloud game application program in a video rendering buffer of the cloud game application program according to an API call of a cloud game streaming library embedded in the cloud game application program executed by a request of a user;
a step of acquiring an address of the video rendering buffer according to the API call of the cloud game streaming library;
a step of acquiring a cloud game streaming video of the cloud game application program by using the address of the video rendering buffer; and
a step of providing the acquired cloud game streaming video to a user terminal requesting the execution of the cloud game application program.

10. The method for providing a streaming video by an application program of claim 9,
wherein the video rendering buffer is formed on a graphic interface built-in memory of the computing device, and is formed separately from a basic video rendering buffer of the cloud game application program.

11. The method for providing a streaming video by an application program of claim 10,
wherein the video rendering buffer is formed on a RAM of the computing device, and is formed separately from the basic video rendering buffer of the cloud game application program.

12. The method for providing a streaming video by an application program of claim 9,
wherein the step of providing the acquired cloud game streaming video to a user terminal requesting the execution of the cloud game application program includes,
a step of acquiring sound data of the cloud game application program in a sound rendering buffer of the cloud game application program from the user terminal;
a step of generating an output sound by encoding sound data of the cloud game application program; and
a step of providing the generated output sound together with the cloud game streaming video to the user terminal.

13. A streaming video providing server of an application program, comprising:
a processor;
a network interface;
a memory; and
a computer program loaded in the memory and executed by the processor,
wherein the computer program includes,
an instruction that separately proceeds a cloud game according to a request of each of two or more user terminals by using a manipulation signal for the two or more cloud games selected according to the request of the two or more user terminals from among a plurality of cloud games;
an instruction that selects two or more cloud game streaming videos according to a preset condition from among a plurality of cloud game streaming videos output by executing a plurality of cloud game applications program in progress;
an instruction that generates one integrated streaming video by combining the selected two or more cloud game streaming videos such that the selected two or more cloud game streaming videos are output on one screen;
an instruction that encodes the integrated streaming video; and
an instruction that extracts a cloud game streaming video corresponding to a cloud game application program requested to be executed from the two or more user terminals from among the encoded integrated streaming videos, and provides the cloud game streaming video to the two or more user terminals,
wherein the instruction that provides the cloud game streaming video to the two or more user terminals includes,
an instruction that extracts cloud game videos in respectively different progress situations corresponding to the cloud game requested to be executed by the two or more user terminals from among the integrated streaming videos, and provides the cloud game streaming video to a corresponding user terminal.
